(19) United States
(12) Patent Application Publication
(10) Pub. No.: US 2012/0052264 A1
(43) Pub. Date: Mar. 1, 2012

(54) WIND SHIELD GLASS FOR DISPLAY AND METHOD THEREOF

(75) Inventor: Dong Eun Cha, Seongnam-si (KR)

(73) Assignee: Hyundai Motor Company, Seoul (KR)

(21) Appl. No.: 12/954,430

(22) Filed: Nov. 24, 2010

(30) Foreign Application Priority Data
Aug. 31, 2010 (KR) 10-2010-0084852

(51) Int. Cl. B32B 17/06; B32B 37/00

(52) U.S. Cl. 428/203; 156/308.2

(57) ABSTRACT

A Wind Shield Glass for a display may include an external glass plate, a pattern part disposed in front of the external glass plate, formed of a combination of at least a line and a blank part, and reflecting an incident image using the at least a line, and an internal glass plate joining to a front side of the pattern part.

### CROSS-REFERENCES TO RELATED APPLICATIONS

The present application claims priority to Korean Patent Application No. 10-2010-0084852, filed on Aug. 31, 2010, the entire contents of which is incorporated herein for all purposes by this reference.

### BACKGROUND OF THE INVENTION

1. Field of the Invention

The present invention relates to a Wind Shield Glass as a display screen and a method thereof.

2. Description of Related Art

Generally, a Head-up display device displays car running information, road guide information, circumference status information in front side of driver, within a range not getting out of a main view line during driving a car, an airplane.

FIG. 1 is a view showing a configuration of a conventional Head-up display device. The conventional Head-up display device comprises a multimedia device 1 displaying car running information, road guide information, and circumference status information; a light path converting part 2 which varies consecutively the path of the image displayed in the multimedia device and enlarges the view angle of image; and a first mirror 3 and a second mirror 4 which reflect the image having an enlarged view angle to the Wind Shield Glass 5 of car and provides to user. Here, the Wind Shield Glass 5 used in the conventional Head-up display device classifies largely two types of coating (Combinder) type and PVB type.

FIG. 2 is a photograph showing a view which an image is formed on the Wind Shield Glass of car by the conventional Head-up display device, FIG. 3 is a side sectional view showing a feature of an image reflection of the conventional coating typed Wind Shield Glass, and FIG. 4 is a side sectional view showing a feature of an image reflect of the conventional PVB typed Wind Shield Glass.

In the coating (Combinder) type, a coating film (TiO2) is formed on the back side (inside direction of car) of an internal glass plate 40 joined with the external glass plate, the coating film makes an image provided from the Head-up display device, and the made image is reflected to eyes of user. In the meantime, though a part of the image provided from the Head-up display device is reflected by the coating film and then provided to user, the remaining part transmits the coating film and then makes also an image (B) on the back side of the internal glass plate. Therefore, there exists a problem that user cannot check the image as it is, since a double image is generated, that is, the image provided from the Head-up display device is made on one surface of the coating film and also on other back side of internal glass plate.

In the meantime, in the PVB type, a PVB film 30a of wedged shape is inserted between an external glass plate 10 and the internal glass plate 40, the PVB film 30a makes an image provided from the Head-up display device and then refracts and reflects the image to driver, namely, user. The PVB film 30a is a safety film which strongly adheres to broken glass pieces to prevent the scattering of broken glass pieces when glass is broken. In other words, the conventional PVB type is such that the PVB film 30a is processed with the wedged shape when viewing in a side section, whereby refracting and reflecting the image displayed in the multimedia device to user's eye. Accordingly, the PVB type can resolve the problem of the double images differently from the conventional coating type. However, the PVB type has a difficulty in designing that a wedged angle of the PVB film should be regulated precisely in order to refract and reflect the image displayed in the multimedia device to user's eye. Thus, there exists a problem in that the designing process of the PVB film 30a complicates and the manufacturing cost is required highly.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a Wind Shield Glass for a display and manufacture method thereof, which is capable of preventing the image forming of double image with respect to the incident image by forming a pattern part constituted of the combination of a line and a blank part between an external glass plate and an internal glass plate, capable of easy manufacturing, and capable of securing transparency having a certain level.

In an aspect of the present invention, the Wind Shield Glass for a display, may include an external glass plate, a pattern part disposed in front of the external glass plate, formed of a combination of at least a line and a blank part, and reflecting an incident image using the at least a line, and an internal glass plate joining to a front side of the pattern part.

The pattern part may be formed with a combination of at least a discontinuous or continuous horizontal, vertical or curved line, formed of a lattice type line, or formed of a combination of one or more circle, ellipse, polygon or fuzzy shape lines, wherein the pattern part may be formed of about 1.6 mm interval between the line and line.

The at least a line reflects a whole or a part of the image to a direction of the internal glass plate, and the blank part may be disposed between the line and line and transmits a whole or a part of the image in a direction of the external glass plate.

A PVB (polyvinyl Butyral) may be interdisposed between the pattern part and the internal glass plate.

A width of the line ranges from 25 to 100 μm.

The pattern part may be formed of oxidized silver (AgO2).

The incident image may be an image generated according to a HUD (Head-up display) function of a smartphone or an image generated in a Head-up display device.

In another aspect of the present invention, the method of manufacturing a Wind Shield Glass for a display, may include (a) forming a pattern part, formed of a combination of at least a line and a blank part on a front side of an external glass plate, and reflecting an incident image using the at least a line, and (b) joining an internal glass plate to a front side of the pattern part.

The pattern part may be formed with a combination of at least a discontinuous or continuous horizontal, vertical or curved line, formed of a lattice type line, or formed of a combination of at least a circle, ellipse, polygon or fuzzy shape line.

The at least a line reflects a whole or a part of the image to a direction of the internal glass plate, and the blank part may be disposed between the line and line and transmits a whole or a part of the image in a direction of the external glass plate.

The pattern part may be formed of about 1.6 mm interval between the line and line.

A width of the at least a line ranges from 25 to 100 μm.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a view showing a configuration of a conventional Head-up display.

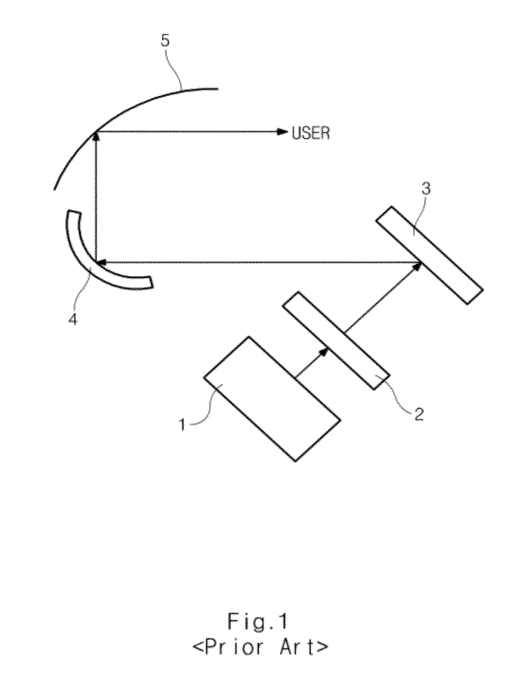

FIG. 2 is a photograph showing a feature which an image is formed on the Wind Shield Glass of car by the conventional Head-up display device.

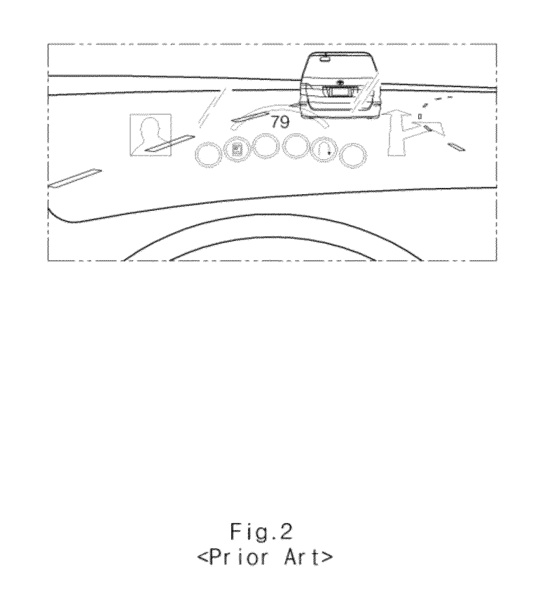

FIG. 3 is a side sectional view showing that the conventional coating typed Wind Shield Glass reflects the image.

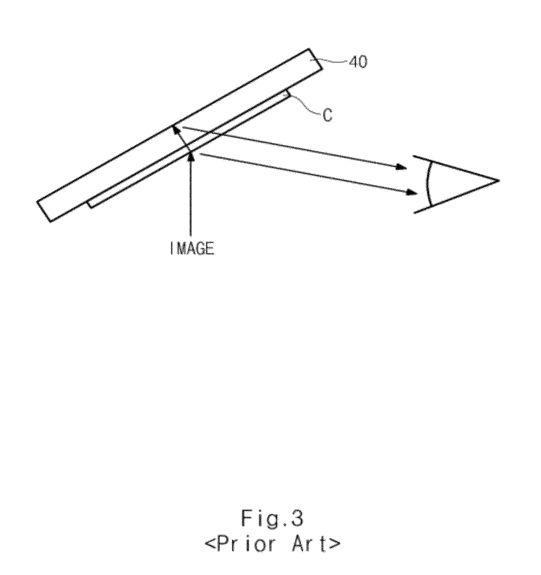

FIG. 4 is a side sectional view showing that the conventional PVB typed Wind Shield Glass reflects the image.

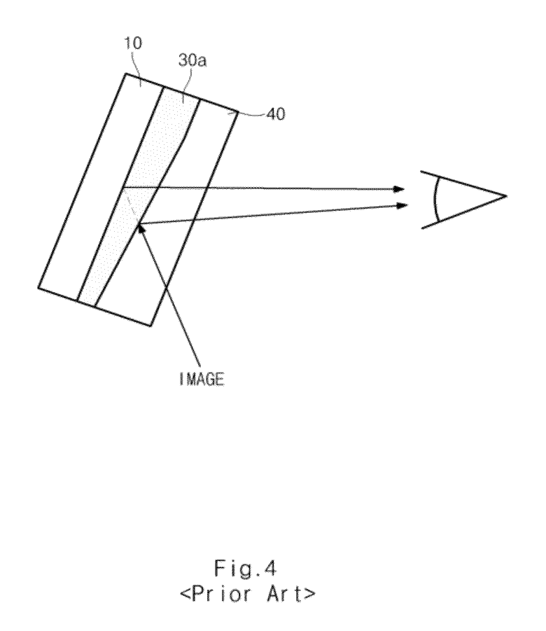

FIG. 5 is a configuration view showing that the Wind Shield Glass 100 for a display in accordance with the present invention receives image from the Head-up display.

FIG. 6 is a configuration view showing that the Wind Shield Glass 100 for a display in accordance with the present invention receives image from a smartphone having a Head-up display function.

FIG. 7 is a side sectional view showing a configuration of the Wind Shield Glass 100 for a display in accordance with the present invention.

FIGS. 8a to 8f are configuration views showing embodiments of a shape of a pattern part 20 of the Wind Shield Glass 100 for a display in accordance with the present invention.

FIG. 9a is a photograph, during a day time, showing a feature watching outside in a car through the Wind Shield Glass 100 for a display in which a pattern part 20 is formed.

FIG. 9b is a photograph, during a day time, showing a feature watching outside in a car through the Wind Shield Glass 100 for a display in which a pattern part where an interval between a line 22 and a blank part 24, and a width of the line 22 are adjusted is formed.

FIG. 10a is a photograph, during a night, showing a feature watching outside in a car through the Wind Shield Glass 100 for a display in which a pattern part 20 is formed.

FIG. 10b is a photograph, during a night, showing a feature watching outside in a car through the Wind Shield Glass 100 for a display in which a pattern part where an interval between the line 22 and the blank part 24, and a width of the line 22 are adjusted is formed.

FIG. 11 is a flow chart showing a process of a manufacturing method of the Wind Shield Glass 100 for a display in accordance with the present invention.

FIG. 12 is a view showing a principle that the line 22 of the pattern part 20 of the Wind Shield Glass 100 of the present invention is integrated to be a surface which can be utilized as a display.

FIG. 13 is a photograph showing an actual operation of the Wind Shield Glass 100 of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

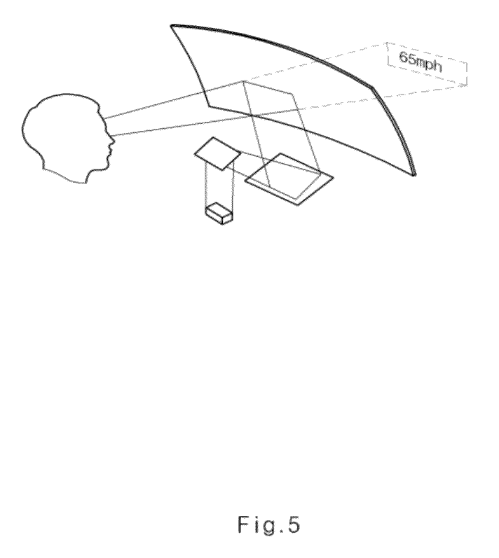

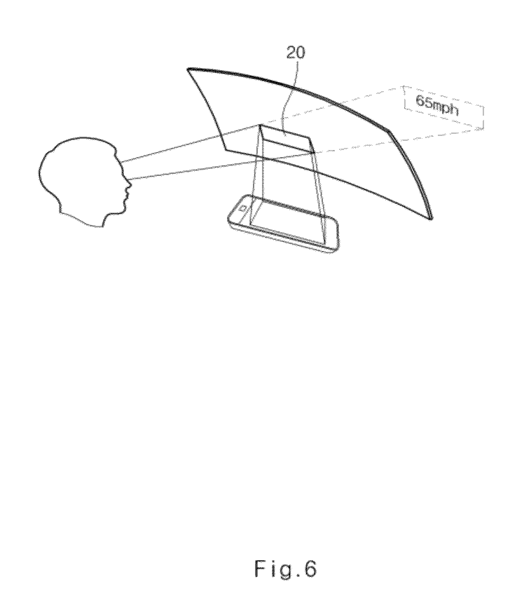

FIG. 5 is a configuration view showing that the Wind Shield Glass 100 for a display in accordance with the present invention receives image from the Head-up display, FIG. 6 is a configuration view showing that the Wind Shield Glass 100 for a display in accordance with the present invention receives image from a smartphone having a Head-up display function.

The Wind Shield Glass 100 for a display in accordance with the present invention is able to receive image of car running information, road guide information, and circumference status information, or the like from an ordinary Head-up display device as mentioned in a conventional technique, or receive the image from a multimedia terminal having the Head-up display function (embodied through application) such as a smartphone, or the like.

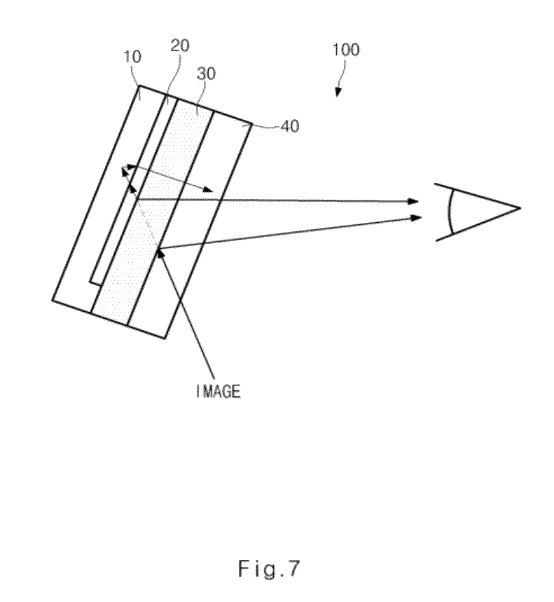

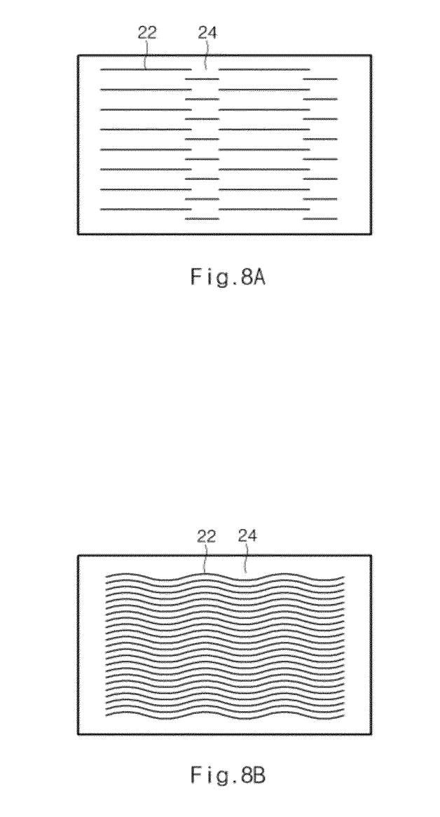

FIG. 7 is a side sectional view showing a configuration of the Wind Shield Glass 100 for a display in accordance with the present invention, FIGS. 8a to 8f are configuration views showing embodiments of a shape of a pattern part 20 of the Wind Shield Glass 100 for a display in accordance with the present invention.

The Wind Shield Glass 100 for a display in accordance with the present invention includes an external glass plate 10, a pattern part 20, a PVB (Polyvinyl Butyral) film 30, and an internal glass plate 40, or the like. The external glass plate 10 is mounted to a car so that a back side exposed to outside of car and a front side faces inside of car.

The pattern part 20 is formed on the front side of the external glass plate 10 and constituted of a combination of at least one line 22 and a blank part 24. The line 22 reflects a whole or a part of the image sent from a multimedia terminal or the Head-up display device. The blank part 24 is disposed between the line 22 and the line 22 and transmits a whole or a part of the image in direction of the external glass plate 10. The PVB film 30 is formed between the pattern part 20 and the internal glass plate 40. The internal glass plate 40 is joined to the front side of the PVB film 30. Hereinafter, elements of the Wind Shield Glass 100 in accordance with the present invention will be described in detail.

[Configuration of External Glass Plate 10, Internal Glass Plate 40 and PVB Film 30]

The external glass plate 10 and the internal glass plate 40 are prepared by an ordinary manufacturing method of a car window glass which is obtained by melting silica, sodium carbonate, calcium carbonate in high degree and then cooling.

The PVB film 30 is generally a safety film for preventing a dispersion of the broken glass pieces when breaking, and is made of main components, that is, 60-90% of PVB resin and 10-40% of plasticizer. The PVB resin is made by the butylation of a PVA. The degree of butylation is adjusted to a proper level so that the joining power reaches a required level when joining with glass. The PVB resin is processed and used in the form of a film having flexibility by adding a proper amount of plasticizer.

The PVB film 30 of the present invention does not have a shape of wedged as the conventional PVB typed Wind Shield Glass 100, but has a shape in which a side section is a cuboid. This PVB film 30 of the present invention has two roles, that is, one is a conventional safety film role and the other role is to transmit light incidenting from the front side, namely, the internal glass plate 40 in direction of the pattern part 20 and the external glass plate 10 which are described later without any refracting.

[Configuration of Pattern Part 20]

The pattern part 20 is formed by a printing method on the front side of the external glass plate 10, and its material includes silver oxide (Ag2O2). The pattern part 20 includes a line 22, and a blank part 24. In the meantime, the pattern part 20 can be selectively formed only on the part for reflecting image in the external glass plate 10 and the internal glass plate 40, namely, only on a specific part for a display to user.

The line 22 reflects a whole or a part of the image. Such line is prepared with at least one, preferably, plural, and is formed with discontinuous or continuous horizontal, vertical or curve. As another example, the line 22 can be formed with a lattice shape, and honeycomb shape, or the like. As still another example, the line 22 can be formed by a combination of any one or more shapes of circle, ellipse, polygon and fuzzy.

In detail, referring to FIG. 8a, the pattern part 20 can be formed with a plurality of discontinuous lines 22 arranged horizontally, and, referring to FIG. 8b, the pattern part 20 can be formed with a plurality of continuous curved lines 22. Referring to FIG. 8c, the pattern part 20 can be formed with a plurality of continuous lines 22 arranged horizontally, and referring to FIG. 8d, the pattern part 20 can be formed with a plurality of continuous fuzzy shaped lines 22.

The pattern part 20 can be formed with a plurality of continuous lines 22 arranged vertically, and the pattern part 20 can be formed with a plurality of continuous lattice shaped line 22. The pattern part 20 can be formed with other shape excepting the above mentioned shape, that is, can be varied to any other shapes in so far as the line 22 and the blank part 24 are included so that a part can be sent and the remaining can be reflected.

In the meantime, that the line 22 reflects a whole of the image means that the transmission rate of the line 22 is 0% while 100% of the image is reflected in direction of the internal glass plate 40. In the meantime, that the line 22 reflects a part of the image means that, for example, a transmission rate of the line 22 is set 70%, and 70% of the image is reflected in direction of the internal glass plate 40 while the remaining 30% of the image is transmitted in direction of the external glass plate 10.

The blank part 24 refers to a portion in which the line is not formed in the pattern part 20. In such blank part 24, actually, nothing may be formed or may be formed with transparent material. Such blank part 24 is disposed between the line 22 and the line 22 and transmits a whole or a part of the image in direction of the external glass plate 10.

Here, that the blank part 24 transmits a whole of the image means that a transmission rate of the blank part 24 is 100% while 100% of the image is transmitted in direction of the external glass plate 10. In the meantime, that the blank part 24 transmits a part of the image means that a transmission rate of the line 24 is set, for example, 90%, while 90% of the image is transmitted in direction of the external glass plate 10 and the remaining 10% of the image is reflected in direction of the internal glass plate 40.

In the meantime, the pattern part 20 is preferably formed of an interval of about 1.6 mm between the line 22 and the line 22, and the width of the line 22 is preferably formed with 25 to 100 μm. That is, when the interval between the line 22 and the line 22 is too far, a reflection rate of a whole pattern part 20 by the line 22 is excessively lowered. On the other hand, when the interval between the line 22 and the line 22 is too near, a reflection rate of a whole pattern part 20 by the line 22 may be excessively increased. Accordingly, a value between the line 22 and the line 22 is determined to be an optimum value 1.6 mm. When the width of the line 22 is too thick, a reflection rate of a whole pattern part 20 by the line 22 is excessively increased. On the other hand, when the width of the line 22 is too thin, a reflection rate of a whole pattern part 20 by the line 22 may be excessively lowered. Thus, the width of the line is determined to be an optimum value 25 to 100 μm.

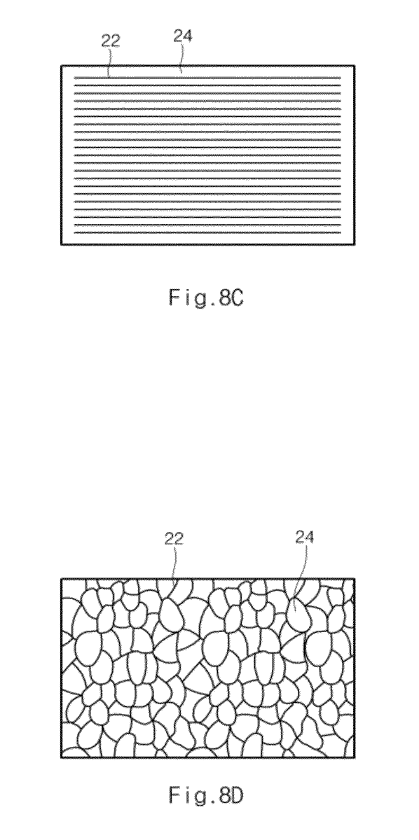

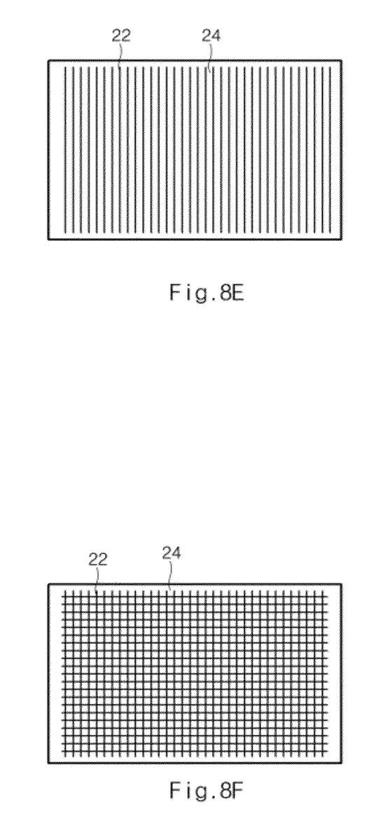

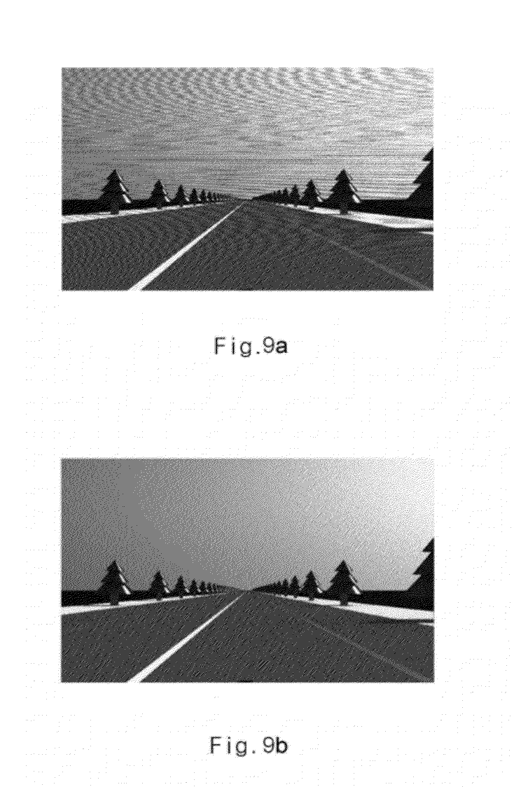

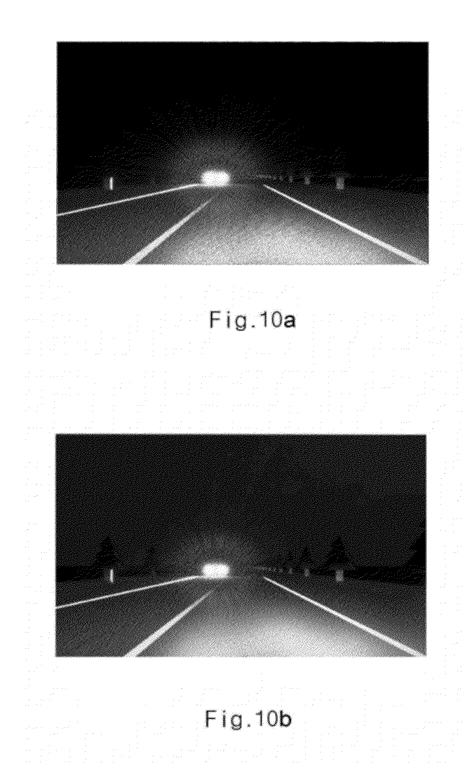

FIG. 9a is a photograph, during a day time, showing a feature watching outside in a car through the Wind Shield Glass 100 for a display in which a pattern part 20 is formed, FIG. 10a is a photograph, during a night, showing a feature watching outside in a car through the Wind Shield Glass 100 for a display in which a pattern part 20 is formed.

Even though the Wind Shield Glass 100 for a display forms a pattern part 20, there exists no distinguishable difference of transparency in comparison with the general Wind Shield Glass during day and night.

FIG. 9b is a photograph, during a day time, showing a feature watching outside in a car through the Wind Shield Glass 100 for a display in which a pattern part where an interval between a line 22 and a blank part 24, and a width of the line 22 are adjusted is formed, FIG. 10b is a photograph, during a night, showing a feature watching outside in a car through the Wind Shield Glass 100 for a display in which a pattern part where an interval between the line 22 and the blank part 24, and a width of the line 22 are adjusted is formed.

The Wind Shield Glass 100 for a display in accordance with the present invention can dynamically control the transmission rate and the reflection rate of Wind Shield Glass for a display by controlling an interval of the line 22 and the blank part 24 and the width of the line 22. Hereinafter a manufacturing method of the Wind Shield Glass of the present invention will be explained.

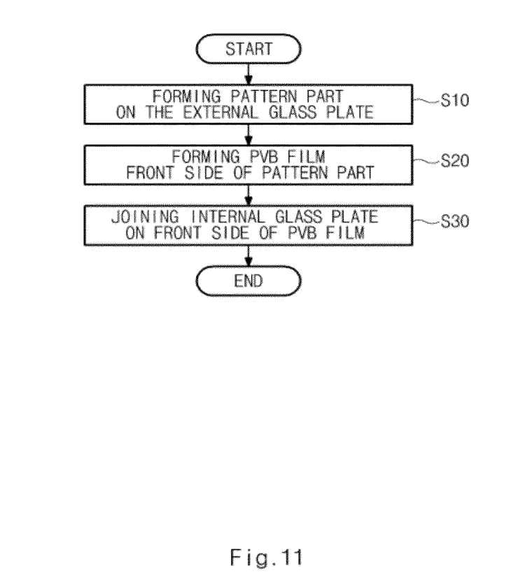

FIG. 11 is a flow chart showing a process of a manufacturing method of the Wind Shield Glass 100 for a display in accordance with the present invention,

First of all, after preparing an external glass plate 10, a pattern part 20 is formed on a part of the front side of glass plate 10(S10).

A PVB film 30 is formed on the front side of the pattern part 20(S20).

An internal glass plate 40 is joined on the front side of the PVB film 30(S30).

Hereinafter an operational principle of the Wind Shield Glass 100 of the present invention will be explained.

When an image is irradiated from an external smartphone or a Head-up display device, the Wind Shield Glass 100 for a display transmits the image to the pattern part 20 through the internal glass plate 40 and the PVB film 30. Here, the line 22 of the pattern part 20 reflects a whole or a part of the image.

Also, a portion in which the line 22 is not formed in the pattern part 20, namely, the blank part 24 transmits a whole or a part of the image in direction of the external glass plate 10. Accordingly, the image is reflected in the line 22 and is transmitted in the blank part 24 to form an image only on the portion of the line 22.

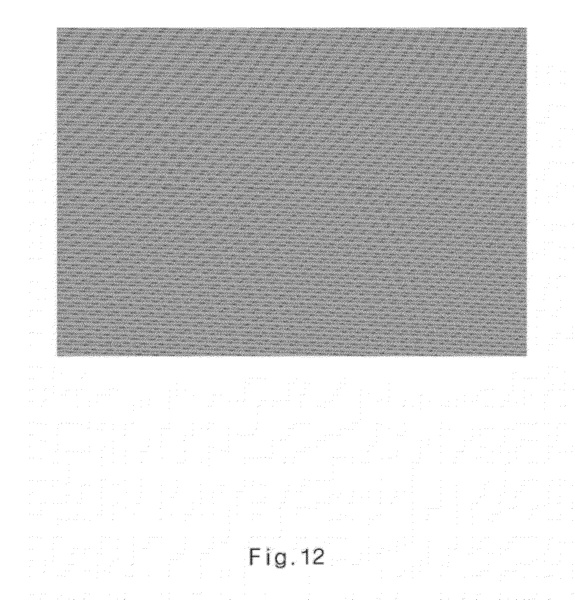

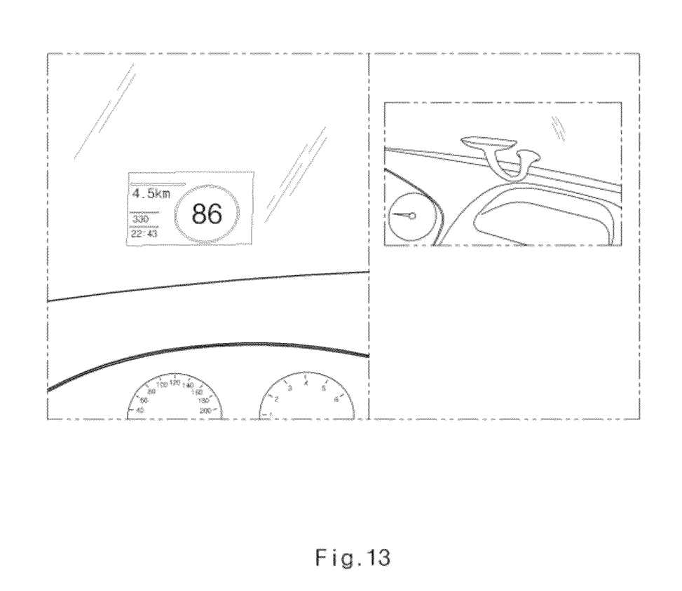

FIG. 12 is a view showing a principle that the line 22 of the pattern part 20 of the Wind Shield Glass 100 of the present invention is integrated to be a surface which can be utilized as a display, FIG. 13 is a photograph showing an actual operation of the Wind Shield Glass 100 of the present invention.

Normally, when a thin line of micron unit is integrated, a surface is obtained. The present invention forms the pattern part 20 which is formed of a combination of the fine line 22 and the blank part 24. Practically, though the blank part 24 exists between the line 22 and the line 22, it is difficult to check the blank part 24 with user's eye. Through such configuration, a double image can be prevented because the image can be reflected effectively through the line 22. Also, by the blank part 24 formed between the line 22 and the line 22, finally, transmission of the Wind Shield Glass 100 for a display can be secured to some extent. Accordingly, the Wind Shield Glass 100 of the present invention is suitable to use as a Wind Shield Glass for a display of car.

For convenience in explanation and accurate definition in the appended claims, the terms “front” and “rear” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A Wind Shield Glass for a display, comprising:
an external glass plate;
a pattern part disposed in front of the external glass plate, formed of a combination of at least a line and a blank part, and reflecting an incident image using the at least a line; and
an internal glass plate joining to a front side of the pattern part.

2. The Wind Shield Glass of claim 1, wherein the pattern part is formed with a combination of at least a discontinuous or continuous horizontal, vertical or curved line, formed of a lattice type line, or formed of a combination of one or more circle, ellipse, polygon or fuzzy shape lines.

3. The Wind Shield Glass of claim 2, wherein the pattern part is formed of about 1.6 mm interval between the line and line.

4. The Wind Shield Glass of claim 1, wherein the at least a line reflects a whole or a part of the image to a direction of the internal glass plate, and the blank part is disposed between the line and line and transmits a whole or a part of the image in a direction of the external glass plate.

5. The Wind Shield Glass of claim 1, wherein a PVB (polyvinyl Butyral) is interdisposed between the pattern part and the internal glass plate.

6. The Wind Shield Glass of claim 1, wherein a width of the line ranges from 25 to 100 μm.

7. The Wind Shield Glass of claim 1, wherein the pattern part is formed of oxidized silver (AgO2).

8. The Wind Shield Glass of claim 1, wherein the incident image is an image generated according to a HUD (Head-up display) function of a smartphone or an image generated in a Head-up display device.

9. A method of manufacturing a Wind Shield Glass for a display, the method comprising:
(a) forming a pattern part, formed of a combination of at least a line and a blank part on a front side of an external glass plate, and reflecting an incident image using the at least a line; and
(b) joining an internal glass plate to a front side of the pattern part.

10. The method of claim 9, wherein the pattern part is formed with a combination of at least a discontinuous or continuous horizontal, vertical or curved line, formed of a lattice type line, or formed of a combination of at least a circle, ellipse, polygon or fuzzy shape line.

11. The method of claim 9, wherein the at least a line reflects a whole or a part of the image to a direction of the internal glass plate, and the blank part is disposed between the line and line and transmits a whole or a part of the image in a direction of the external glass plate.

12. The method of claim 10, wherein the pattern part is formed of about 1.6 mm interval between the line and line.

13. The method of claim 9, wherein a width of the at least a line ranges from 25 to 100 μm.
